(19) United States
(12) Patent Application Publication
(10) Pub. No.: US 2006/0129549 A1
(43) Pub. Date: Jun. 15, 2006

(54) Topic-focused web navigation

(76) Inventors: Erol Bozak, Pforzheim (DE); Alexander Gebhart, Bad Schoenborn (DE)

Correspondence Address: FISH & RICHARDSON, P.C., PO BOX 1022, MINNEAPOLIS, MN, 55440-1022, US

(21) Appl. No.: 11/011,694

(22) Filed: Dec. 14, 2004

(51) Int. Cl. G06F 17/30

(52) U.S. Cl. 707/5

(57) ABSTRACT

A method includes, in a network of interconnected computer systems, storing a first list of links represented as universal resource locators (URLs) that match a first search request, displaying a first page in response to a navigational input, highlighting links on a second displayed page that match links contained in the stored first list.

### TECHNICAL FIELD

The present invention relates to data processing by digital computer, and more particularly to topic-focused web navigation.

### BACKGROUND

The Internet, sometimes called simply “the Net,” is a worldwide system of interconnected computer networks—a network of networks in which users at any one computer can, if they have permission, get information from any other computer. The World Wide Web (“Web”) refers to all the resources and users on the Internet that are using the Hypertext Transfer Protocol (HTTP).

Users on the Internet and Web can request information from resources using a search engine, typically through a graphical user interface (GUI) referred to as a browser. A search engine is a coordinated set of programs that includes a spider, a catalog and a program that receives a search request. A spider (also called a “crawler”) goes to every page or representative pages on every Web site that is searchable and reads it, using hypertext links on each page, to discover and read a site's other pages. A catalog is a program that generates a huge index from the pages that have been read. The program that receives a search request compares the request to the entries in the index, and returns results.

An alternative to using a search engine is to explore a structured directory of topics. A number of Web portal sites offer both search engine and directory approaches to finding information.

### SUMMARY

The present invention provides methods and apparatus, including computer program products, for topic-focused web navigation.

In an aspect, the invention features a method including, in a network of interconnected computer systems, storing a first list of links represented as universal resource locators (URLs) that match a first search request, displaying a first page in response to a navigational input, highlighting links on a second displayed page that match links contained in the stored first list.

In embodiments, the first list includes links ranked by importance and relevance. Displaying can include a Web browser. The Web browser can include a topic focused navigation plug-in. The Web browser can load the stored first list. The plug-in can load the stored first list. The Web browser can include a proxy that loads the stored first list. Highlighting can include displaying the links in a color.

Storing can include storing a second list of links represented as URLs that match a second search request. Highlighting can include highlighting links on the page that match links in the first list with a first color, and highlighting links on the page that match links in the second list with a second color. Highlighting can include displaying the links that match a predefined relevance factor in a color.

Embodiments of the invention may have one or more of the following advantages.

The user specifies a set of subjects he is interested in and searches associated pages with a public search engine or through any other internet directory. Each hit for a specific subject is ranked according to its importance and relevance. The Browser application (or a plug-in) retrieves the hit lists and stores them to a local database. For the initial navigation the user selects one link from the lists and navigates to the associate site. At this point the topic focused navigation process is activated and ensures that the links, which refer to a hit in the lists, in a displayed page are highlighted according to the topic and their ranking. Links that are not in the hit list are not highlighted or even disabled, which can be user-defined. Multiple topics are indicated via different coloring.

Since all links that are not of interest are disabled, i.e. they refer to pages that are not in any hit list, the user can focus navigation only on those pages that are relevant for him.

Through highlighting and indication the user can see how relevant the page might be if he intends to follow the link.

User can see which links reference to which topics since links are highlighted with a color that is associated with the topic.

The process can be realized as a browser plug-in or through a proxy server implementation. In the latter case the proxy renders the pages the user wants to be displayed. The user always gets rendered pages that are enriched via highlighted links described above.

The relevance of a page according to its associated topic can be indicated through different color depths, e.g. the more interesting the page the darker the color of the associated links.

A user may be interested only in pages that have a specific relevance. He may decide to limit the highlighting only on those pages whose relevance factor is greater than, for example, 80%. The rest would be disabled.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is block diagram.

FIG. 2 is a block diagram.

FIG. 3 is a flow diagram.

FIG. 4 is a block diagram.

Like reference symbols in the various drawings indicate like elements.

### DETAILED DESCRIPTION

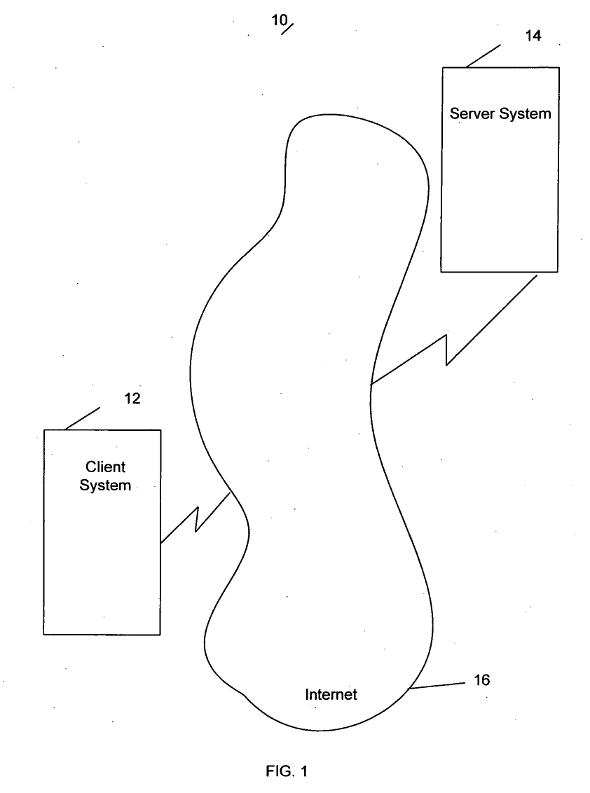

As shown in FIG. 1, a client/server network 10 in accordance with one embodiment of the invention includes a client system 12 and a server system 14 linked through a network of interconnected computers (e.g., Internet) 16. In general, client/server describes a relationship between two computer programs in which one program, the client, makes a service request from another program, the server, which fulfills the request. Although the client/server idea can be used by programs within a single computer, it is a more important idea in a network, such as network 10. In the network 10, the client/server model provides a convenient way to interconnect programs that are distributed efficiently across different locations.

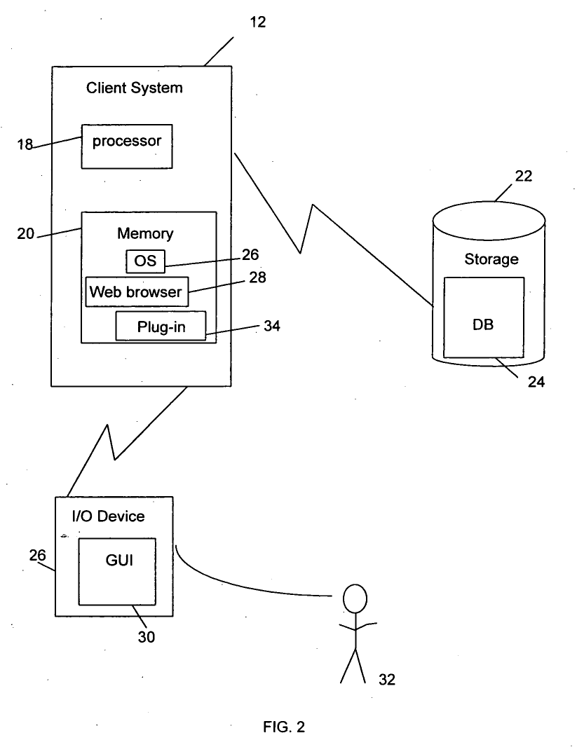

As shown in FIG. 2, client system 12 includes, for example, a processor 18, a memory 20, a local storage device 22 that stores a database 24 and an input/output (I/O) device 26. Memory 20 includes an operating system (OS) 26, such as Linux, Unix or Windows, and a Web browser 28, such as Netscape Navigator, Mozilla or Firefox. The I/O device 26 can include a graphical user interface (GUI) 30 generated by the Web browser 28 for display to a user 32.

A Web browser is a client program that uses the Hypertext Transfer Protocol (HTTP) to make requests of Web servers (e.g., server system 14) throughout the Internet (e.g., network 16) on behalf of a browser user (e.g., user 32). In a particular example, Web browser 28 includes a topic-focusing navigational plug-in 34. In general, a plug-in is an application program that can easily be installed and used as part of a Web browser (e.g., Web browser 28). A plug-in is recognized automatically by the Web browser 28 and its function is integrated into a main HTML file that is being presented. Plug-in 34 highlights or does not highlight links on a displayed page with respect to the user's 32 focus of interest.

In a particular example, the user 32 specifies a subject of interest and searches associated pages with a search engine (e.g., Google™, Yahoo®, AltaVista™) or any other Internet directory. The search engine ranks importance and relevance of specific subject matches (sometimes referred to as “hits”). The matches are displayed to the user 32 as a list of links on the GUI 30 and the list of links stored in the database 24 of the local storage device 22. The list of links that are stored in the database 24 are generally referred to as the user's “focus of interest”. When the user 32 navigates to a specific link in the displayed list, the page (e.g., content) associated with the specific link is displayed. The plug-in 34 checks links on the display against those stored in the database 24 (e.g., the user's focus of interest). Any link displayed on the page associated with the specific link and determined by the plug-in 34 to be in the database 24 is highlighted by the plug-in 34 on the GUI 30. Highlighting can include, for example, presenting the link in an alternate color, flashing the link, bolding the link, and so forth. Highlighting can also be according to rank, as stored in the database 24. In this manner, the browser plug-in 34 highlights and does not highlight and/or disables links on a displayed page in respect to the user's focus of interest. Since all links that are not of interest are disabled (or not highlighted), i.e., they refer to pages that are not in any hit list, the user 32 can focus navigation only on those pages that are relevant to him or her. Through highlighting and indication the user 32 can see how relevant the page might be if he/she intends to follow the link. In a particular example, the user 32 can see which links reference to which topics since links can be highlighted with a color that is associated with particular topics. A relevance of a page according to its associated topic can be indicated through different color depths, e.g., a link of interest appears darker when displayed than other non-interesting links.

In another particular example, links on the displayed page associated with the specific link that are not in the database 24 are not highlighted. In other examples, links on the page that are not contained with the list are disabled. Highlighting/not highlighting and disabling can be combined.

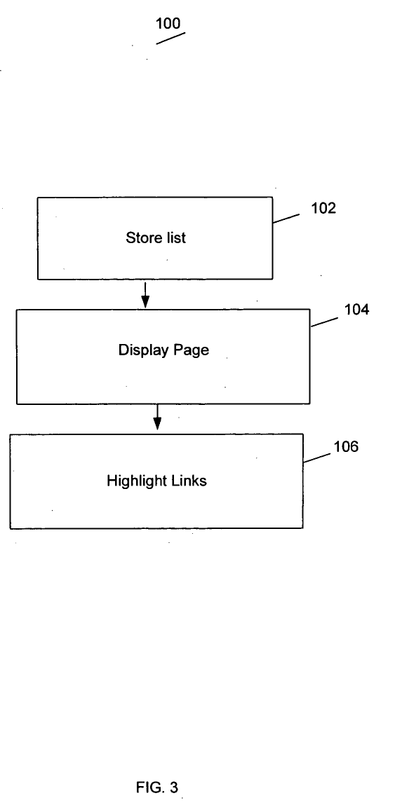

As shown in FIG. 3, a process 100 for topic-focused navigation includes, in a network of interconnected computer systems, storing (102) a first list of links represented as universal resource locators (URLs) that match a first search request. The first list can include links ranked by importance and relevance.

Process 100 displays (104) a first page in response to a navigational input. Displaying (104) includes a Web browser that can include a topic focused navigation plug-in or a proxy that loads the stored first list.

Process 100 highlights (106) links on a second displayed page that match links contained in the stored first list. Highlighting (106) can include bolding, flashing and/or coloring that links. Highlighting (106) can include displaying the links that match a predefined relevance factor in a color.

Process 100 can include storing a second list of links represented as URLs that match a second search request, highlighting links on the page that match links in the first list with a first color, and highlighting links on the page that match links in the second list with a second color.

Process 100 can be used when the user 32 wishes to focus on more than one topic.

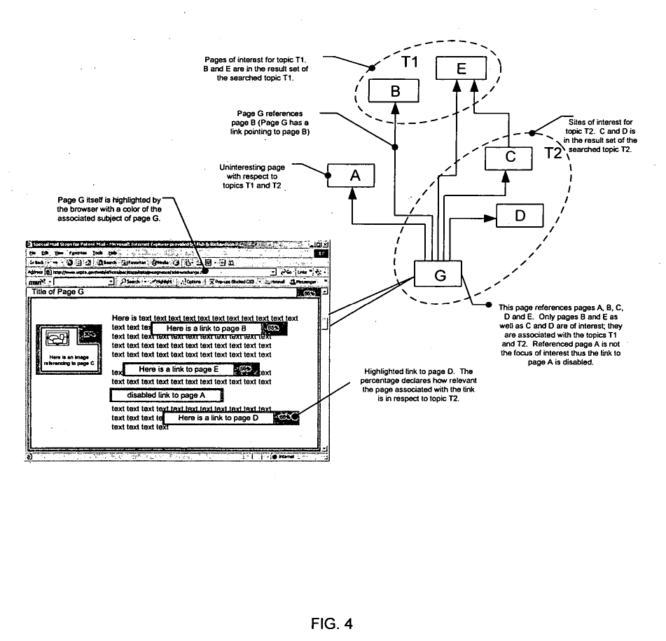

As shown in FIG. 4, an example assumes the user 32 intends to focus his/her navigation on two topics T1 and T2. A search in a public internet directory results in two lists with Internet addresses (i.e., links). Each list is sorted by a search engine according to a relevance of the link, e.g., each link is associated with a percentage denoting how relevant a page is with respect to a topic. Pages G, D and C are in a topic of interest list for topic T2 and pages B and E are in the topic of interest list for topic T1. Page G is currently displayed to the user 32. Page G contains links referencing other pages, i.e., pages A, B, C, D and E. The browser that displays page G highlights only those links that are associated with the searched topic T1 and topic T2.

The invention can be implemented in digital electronic circuitry, or in computer hardware, firmware, software, or in combinations of them. The invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto [ ] optical disks; and CD□ROM and DVD-ROM disks. The processor and the memory can be supplemented by, or incorporated in special purpose logic circuitry.

What is claimed is:

1. A method comprising:
in a network of interconnected computer systems, storing a first list of links represented as universal resource locators (URLs) that match a first search request;
displaying a first page in response to a navigational input;
highlighting links on a second displayed page that match links contained in the stored first list.

2. The method of claim 1 wherein the first list includes links ranked by importance and relevance.

3. The method of claim 1 wherein displaying comprises a Web browser.

4. The method of claim 3 wherein the Web browser comprises a topic focused navigation plug-in.

5. The method of claim 4 wherein the Web browser loads the stored first list.

6. The method of claim 3 wherein the plug-in loads the stored first list.

7. The method of claim 3 wherein the Web browser includes a proxy that loads the stored first list.

8. The method of claim 1 wherein highlighting comprises displaying the links in a color.

9. The method of claim 1 wherein storing further comprises storing a second list of links represented as URLs that match a second search request.

10. The method of claim 9 wherein highlighting comprises:
highlighting links on the page that match links in the first list with a first color; and
highlighting links on the page that match links in the second list with a second color.

11. The method of claim 1 wherein highlighting comprises displaying the links that match a predefined relevance factor in a color.

12. A computer program product, tangibly embodied in an information carrier, for topic focused navigation in a network of interconnected computer systems, the computer program product being operable to cause data processing apparatus to:
store a first list of links represented as universal resource locators (URLs) that match a first search request;
display a first page in response to a navigational input;
highlight links on a second displayed page that match links contained in the stored first list.

13. The product of claim 12 wherein the first list includes links ranked by importance and relevance.

14. The product of claim 12 wherein displaying comprises a Web browser.

15. The product of claim 14 wherein the Web browser comprises a topic focused navigation plug-in.

16. The product of claim 15 wherein the Web browser loads the stored first list.

17. The product of claim 14 wherein the plug-in loads the stored first list.

18. The product of claim 14 wherein the Web browser includes a proxy that loads the stored first list.

19. The product of claim 12 wherein highlighting comprises displaying the links in a color.

20. The product of claim 12 wherein storing further comprises storing a second list of links represented as URLs that match a second search request.

21. The product of claim 20 wherein highlighting comprises:
highlighting links on the second page that match links in the first list with a first color; and
highlighting links on the second page that match links in the second list with a second color.

22. The product of claim 12 wherein highlighting comprises displaying the links that match a predefined relevance factor in a color.

23. A system for topic focused web navigation comprising:
in a network of interconnected computer systems, means for storing a first list of links represented as universal resource locators (URLs) that match a first search request;
means for displaying a first page in response to a navigational input;
means for highlighting links on a displayed second page that match links contained in the stored first list.

24. The system of claim 23 wherein the first list includes links ranked by importance and relevance.

25. The system of claim 23 wherein means for displaying comprises a Web browser.

26. The system of claim 25 wherein the Web browser comprises a topic focused navigation plug-in.

27. The system of claim 26 wherein the Web browser loads the stored first list.

28. The system of claim 25 wherein the plug-in loads the stored first list.

29. The system of claim 25 wherein the Web browser includes a proxy that loads the stored first list.

30. The system of claim 23 wherein means for highlighting comprises displaying the links in a color.

31. The system of claim 23 wherein means for storing further comprises means for storing a second list of links represented as URLs that match a second search request.

32. The system of claim 31 wherein means for highlighting comprises:
highlighting links on the second page that match links in the first list with a first color; and
highlighting links on the second page that match links in the second list with a second color.

33. The system of claim 23 wherein means for highlighting comprises displaying the links that match a predefined relevance factor in a color.
